(19) United States
(12) Patent Application Publication
(10) Pub. No.: US 2025/0089026 A1
(43) Pub. Date: Mar. 13, 2025

(54) METHOD AND APPARATUS FOR TRANSMITTING AND RECEIVING REFERENCE SIGNAL FOR POSITIONING

(71) Applicant: Samsung Electronics Co., Ltd., Gyeonggi-do (KR)

(72) Inventors: Pengru LI, Beijing (CN); Qi XIONG, Beijing (CN); Feifei SUN, Beijing (CN)

(21) Appl. No.: 18/722,981

(22) PCT Filed: Dec. 22, 2022
(86) PCT No.: PCT/KR2022/021014

§ 371 Date: Jun. 21, 2024

(30) Foreign Application Priority Data
Jan. 6, 2022 (CN) 202210010308.9
Jan. 27, 2022 (CN) 202210103007.0
Feb. 7, 2022 (CN) 202210116834.3

(51) Int. Cl. H04W 72/0446; H04W 74/0833; H04W 76/27

(52) U.S. Cl. CPC H04W 72/0446; H04W 74/0833; H04W 76/27

(57) ABSTRACT

The present disclosure relates to a 5G communication system or a 6G communication system for supporting higher data rates beyond a 4G communication system such as long term evolution (LTE). The application provides a method performed by a user equipment UE, comprising: identifying a first time interval between a first transmission of an SRS for positioning outside an initial uplink BWP and a second transmission of an uplink signal; and in case that the first time interval between the first transmission and the second transmission is less than a first threshold, dropping the first transmission. The application also provides a UE performing the method.

### TECHNICAL FIELD

The disclosure relates to a wireless (or, mobile) communication system. More specifically, the disclosure relates to a method and apparatus for transmitting and receiving positioning related reference signals, and measuring positioning signals in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

There are needs to enhance procedures of transmission and reception of positioning reference signal.

### Solution to Problem

According to one aspect of the present invention, there is provided a method performed by a user equipment UE, comprising: when the time interval between the positioning reference signal PRS and other downlink signals is smaller than the first threshold and/or the frequency domain interval is smaller than the second threshold, the other downlink signals are preferentially received.

In another aspect of the present invention, there is provided a method performed by the user equipment UE, wherein the first threshold and/or the second threshold are threshold parameter values determined by the user equipment UE subject to UE capability and/or threshold parameter values received by the UE and configured by a base station.

In another aspect of the present invention, there is provided a method performed by the user equipment UE, wherein the first threshold and/or the second threshold are configured by the base station based on the value N reported by the user equipment UE subject to UE capability.

In another aspect of the present invention, there is provided a method performed by the user equipment UE, wherein the user equipment UE determines to receive the other downlink signals preferentially within a specific window, wherein the specific window is a measurement interval and/or a positioning reference signal PRS processing window and/or a window corresponding to the measurement of the positioning reference signal PRS.

In another aspect of the present invention, there is provided a method performed by the user equipment UE, wherein the other downlink signals include a first downlink signal including at least one of the following: a synchronization signal block SSB, a system information block 1 SIB1, a control resource set 0 CORESET0, a message 2 MSG2, a message B MSGB, a paging signal, and a downlink small data transmission DL SDT.

In another aspect of the present invention, there is provided a method performed by the user equipment UE, comprising: when a first condition between a positioning reference signal PRS and other downlink signals is satisfied, it is determined that the positioning reference signal PRS conflicts with the other downlink signals.

In another aspect of the present invention, there is provided a method performed by the user equipment UE, wherein the other downlink signals include a first downlink signal including at least one of the following: a synchronization signal block SSB, a system information block 1 SIB1, a control resource set 0 CORESET0, a message 2 MSG2, a message B MSGB, a paging signal, and a downlink small data transmission DL SDT.

In another aspect of the present invention, there is provided a method performed by the user equipment UE, wherein the first condition comprises a combination of one or more of the following: 1) the positioning reference signal PRS partially and/or completely overlaps/conflicts with other downlink signals on frequency domain unit of the same frequency band/carrier; 2) the positioning reference signal PRS partially and/or completely overlaps/conflicts with other downlink signals on frequency domain units of different frequency bands/carriers; 3) the positioning reference signal PRS and other downlink signals are on time domain units of the same frequency band/carrier and/or different frequency bands/carriers; 4) the time interval between the end position of the other downlink signals and the start position corresponding to the first positioning reference signal PRS is smaller than the threshold N1; or 5) the time interval between the end position of the positioning reference signal PRS and the start position corresponding to other downlink signals is smaller than the threshold N2.

In another aspect of the present invention, there is provided a method performed by the user equipment (UE), further comprising: when the first condition between the positioning reference signal PRS and the other downlink signals is not satisfied, but a second condition is satisfied, the user equipment UE simultaneously receives the positioning reference signal PRS and the other downlink signals.

In another aspect of the present invention, there is provided a method performed by the user equipment UE, wherein the second condition comprises a combination of one or more of the following: 1) when the positioning reference signal PRS resource is within the bandwidth part BWP where other downlink signals are located; 2) when the positioning reference signal PRS resource is outside the bandwidth part BWP where other downlink signals are located; 3) when the numerology configuration is the same as that of the bandwidth part BWP; 4) when the numerology configuration is different from that of the bandwidth part BWP; 5) the time interval between the time domain end position of other downlink signals and the time domain start position corresponding to the nearest first positioning reference signal PRS is greater than the threshold N1; 6) the time interval between the time domain end position of other downlink signals and the time domain start position corresponding to the nearest first positioning reference signal PRS is greater than the threshold L-N1, wherein L is the start position of the positioning reference signal PRS resource instance; or 7) the time interval between the time domain end position of the first positioning reference signal PRS, or the time domain end position of the last positioning reference signal PRS generated by repeatedly measuring the first positioning reference signal PRS, or the time domain end position of the last positioning reference signal PRS generated by measuring a plurality of positioning reference signals PRSs and the time domain start position corresponding to the nearest next other downlink signal is greater than the threshold N2.

In another aspect of the present invention, there is provided a method performed by the user equipment UE, further comprising: when the first condition between the positioning reference signal PRS and the other downlink signals is satisfied, and a third condition is satisfied, the user equipment UE preferentially receives the other downlink signals.

In another aspect of the present invention, there is provided a method performed by the user equipment UE, wherein the third condition comprises a combination of one or more of the following: 1) when the positioning reference signal PRS resource is within the bandwidth part BWP where the other downlink signals are located; 2) when the positioning reference signal PRS resource is outside the bandwidth part BWP where the other downlink signals are located; 3) when the numerology configuration is the same as that of the bandwidth part BWP; 4) when the numerology configuration is different from that of the bandwidth part BWP; 5) the time interval between the time domain end position of the other downlink signals and the time domain start position corresponding to the nearest first positioning reference signal PRS is greater than the threshold N1; 6) the time interval between the time domain end position of the other downlink signals and the time domain start position corresponding to the nearest first positioning reference signal PRS is greater than the threshold L-N1, wherein L is the start position of the positioning reference signal PRS resource instance; 7) the time interval between the time domain end position of the first positioning reference signal PRS, or the time domain end position of the last positioning reference signal PRS generated by repeatedly measuring the first positioning reference signal PRS, or the time domain end position of the last positioning reference signal PRS generated by measuring a plurality of positioning reference signals PRSs and the time domain start position corresponding to the nearest next other downlink signal is smaller than the threshold N2; and/or 8) when the time interval between the positioning reference signal PRS and other downlink signals is smaller than the first threshold and/or the frequency domain interval is smaller than the second threshold.

In another aspect of the present invention, there is provided a method performed by the user equipment UE, further comprising: when the time interval between uplink UL signals transmitted in an initial uplink bandwidth part UL BWP and/or other uplink bandwidth parts UL BWPs and one or more periodic sounding reference signals SRSs for positioning transmitted outside the initial uplink bandwidth part UL BWP and/or other uplink bandwidth parts UL BWPs is less than (or not greater than) a first threshold, the user equipment UE will not transmit or cancel transmitting or discard the one or more sounding reference signals SRSs for positioning.

In another aspect of the present invention, there is provided a method performed by the user equipment UE, further comprising: when the time interval between uplink UL signals transmitted in an initial uplink bandwidth part UL BWP and/or other uplink bandwidth parts UL BWPs and one or more periodic sounding reference signals SRSs for positioning transmitted outside the initial uplink bandwidth part UL BWP and/or other uplink bandwidth parts UL BWPs is greater than a third threshold, the user equipment UE is allowed or expected to transmit the one or more sounding reference signals SRSs for positioning.

In another aspect of the present invention, there is provided a method performed by the user equipment UE, wherein the first threshold and/or the second threshold and/or the third threshold are threshold parameter values determined by the user equipment UE subject to UE capability and/or threshold parameter values received by the user equipment UE and configured by the base station.

In another aspect of the present invention, there is provided a method performed by the user equipment UE, wherein the user equipment UE determines the thresholds N1 and N2 by default and/or by receiving an indication from the base station.

In another aspect of the present invention, there is provided a method performed by the user equipment UE, wherein the threshold N1 and the threshold N2 are the same threshold parameter values.

In another aspect of the present invention, there is provided a method performed by the user equipment UE, wherein the user equipment UE applies at least one of the first condition, the second condition and/or the third condition in the specific window, wherein the specific window is a measurement interval and/or a positioning reference signal PRS processing window and/or a window corresponding to the measurement of the positioning reference signal PRS.

In another aspect of the present invention, there is provided a user equipment UE, comprising: a memory configured to store computer programs; and a processor configured to implement any of the methods described above.

### Advantageous Effects of Invention

According to various embodiments of the disclosure, procedures regarding transmitting and receiving of positioning related reference signals can be efficiently enhanced.

### BRIEF DESCRIPTION OF DRAWINGS

FIG. 1 shows a schematic diagram of an example wireless network 100 according to various embodiments of the present disclosure.

FIG. 2A show schematic diagrams of example wireless transmission and reception paths according to the present disclosure.

FIG. 2B show schematic diagrams of example wireless transmission and reception paths according to the present disclosure.

FIG. 3A shows a schematic diagram of an example UE 116 according to the present disclosure.

FIG. 3B shows a schematic diagram of an example gNB 102 according to the present disclosure.

FIG. 4 shows a schematic diagram of a reception measurement method of a downlink positioning reference signal PRS based on a positioning reference signal PRS processing window according to an embodiment of the present invention.

FIG. 5 shows a block diagram showing an electronic device of a method for executing the PRS processing window according to an embodiment of the present invention.

FIG. 6 illustrates a block diagram of a terminal (or a user equipment (UE)) according to an embodiment of the disclosure.

FIG. 7 illustrates a block diagram of a base station according to an embodiment of the disclosure.

### BEST MODE FOR CARRYING OUT THE INVENTION

The following description with reference to the drawings is provided to facilitate a comprehensive understanding of various embodiments of the present disclosure defined by the claims and their equivalents. This description includes various specific details to facilitate understanding but should only be considered as exemplary. Therefore, those skilled in the art will recognize that various changes and modifications can be made to the various embodiments described herein without departing from the scope and spirit of the present disclosure. In addition, for the sake of clarity and conciseness, the description of well-known functions and structures may be omitted.

Terms and expressions used in the following specification and claims are not limited to their dictionary meanings, but are only used by the inventors to enable a clear and consistent understanding of the present disclosure. Therefore, it should be obvious to those skilled in the art that the following descriptions of various embodiments of the present disclosure are provided only for the purpose of illustration and not for the purpose of limiting the present disclosure as defined by the appended claims and their equivalents.

It should be understood that singular forms of “a”, “an” and “the” include plural referents, unless the context clearly indicates otherwise. Thus, for example, reference to “a component surfaces” includes reference to one or more such surfaces.

The term “including” or “may include” refers to the existence of the corresponding disclosed functions, operations or components that can be used in various embodiments of the present disclosure, rather than limiting the existence of one or more additional functions, operations or features. In addition, the terms “including” or “having” can be interpreted to indicate certain features, numbers, steps, operations, constituent elements, components or combinations thereof, but should not be interpreted to exclude the possibility of the existence of one or more other features, numbers, steps, operations, constituent elements, components or combinations thereof.

The term “or” used in various embodiments of the present disclosure includes any listed terms and all combinations thereof. For example, “A or B” may include A, B, or both A and B.

Unless otherwise defined, all terms (including technical terms or scientific terms) used in this disclosure have the same meanings as understood by those skilled in the art as described in this disclosure. Common terms as defined in dictionaries are interpreted to have meanings consistent with the context in relevant technical fields, and should not be interpreted with idealized or overly formal meanings unless specifically defined as here.

The technical scheme of this embodiment can be applied to various communication systems, such as Global System for Mobile Communications (GSM) system, code division multiple access (CDMA) system, Wideband Code Division Multiple Access (WCDMA) system, general packet radio service (GPRS), long term evolution (LTE) system, LTE frequency division duplex (FDD) system, LTE time division duplex (TDD), universal mobile telecommunications system (UMTS), worldwide interoperability for microwave access (WiMAX) communication system, 5th generation (5G) system or new radio (NR), etc. In addition, the technical scheme of the embodiment of this application can be applied to future-oriented communication technology.

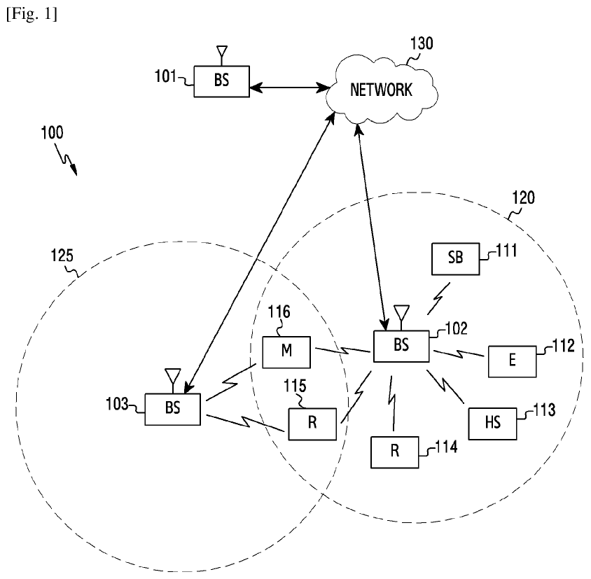

FIG. 1 shows an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. Other well-known terms such as “mobile station”, “user station”, “remote terminal”, “wireless terminal” or “user apparatus” can be used instead of “user equipment” or “UE”, depending on the type of the network. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

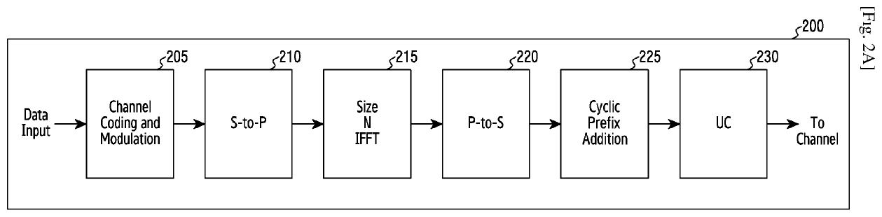

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at the UE 116 after passing through the wireless channel, and operations in reverse to those at gNB 102 are performed at the UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

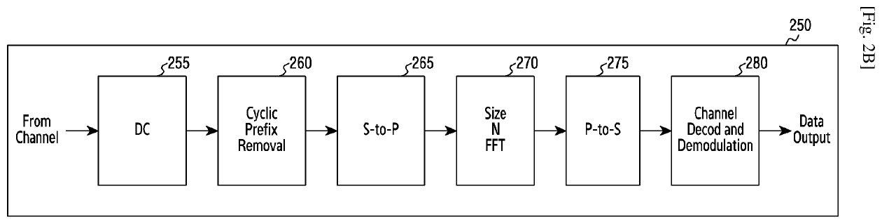

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of performing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of performing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The time domain unit (also called time unit) in this invention can be: an OFDM symbol, an OFDM symbol group (composed of multiple OFDM symbols), a time slot, a time slot group (composed of multiple time slots), a subframe, a subframe group (composed of multiple subframes), a system frame and a system frame group (composed of multiple system frames). The time unit can also be an absolute time unit, such as 1 millisecond, 1 second, etc. Furthermore, the time unit can also be a combination of various granularities, such as N1 time slots plus N2 OFDM symbols.

The frequency domain unit in this invention can be: a subcarrier, a subcarrier group (composed of multiple subcarriers), a resource block (RB), which can also be called a physical resource block (PRB), a resource block group (composed of multiple RBs), a band part (BWP), a band part group (composed of multiple BWPs), a band/carrier, a band group/carrier group. The frequency domain unit can also be an absolute frequency domain unit, such as 1 Hz, 1 kHz, etc. Furthermore, the frequency domain unit can also be a combination of various granularities, such as M1 PRBs plus M2 subcarriers.

Exemplary embodiments of the present disclosure are further described below with reference to the accompanying drawings.

The text and drawings are only provided as examples to assist readers in understanding the present disclosure. They are not intended and should not be construed to limit the scope of the present disclosure in any way. While certain embodiments and examples have been provided, it will be apparent to those skilled in the art based on the disclosure herein that the illustrated embodiments and examples can be modified without departing from the scope of the present disclosure.

Those skilled in the art can understand that the singular forms “a”, “an”, and “the” used here can also include plural forms unless specifically stated. It should be further understood that the word “comprising” used in the specification of this application means the presence of said features, integers, steps, operations, elements and/or components, but does not exclude the presence or addition of one or more other features, integers, steps, operations, elements, components and/or groups thereof. It should be understood that when an element is described as “connected” or “coupled” to another element, it may be directly connected or coupled to other elements, or there may be intervening elements. In addition, as used herein, the statements “connected” or “coupled” may include wireless connection or wireless coupling. As used herein, the phrase “and/or” includes all or any unit and all combinations of one or more associated listed items.

Those skilled in the art can understand that unless otherwise defined, all terms (including technical terms and scientific terms) used here have the same meaning as those commonly understood by ordinary technicians in the field to which this application belongs. It should also be understood that terms such as those defined in the general dictionary should be understood to have meanings consistent with those in the context of the prior art, and will not be interpreted with idealized or overly formal meanings unless specifically defined as here.

It can be understood by those skilled in the art that “terminal” and “terminal equipment” used here include not only the equipment including wireless signal receiver which is a wireless signal receiving equipment without capability of transmitting signals, but also the equipment including receiving and transmitting hardware which is capable of bidirectional communication on bidirectional communication link. Such devices may include: cellular or other communication devices with single-line display or multi-line display or cellular or other communication devices without multi-line display; PCS (Personal Communications Service), which can combine voice, data processing, fax and/or data communication capabilities; PDA (Personal Digital Assistant), which may include radio frequency receiver, pager, internet/intranet access, web browser, notepad, calendar and/or GPS (Global Positioning System) receiver; conventional laptops and/or palmtop computers or other devices having and/or including a radio frequency receiver. As used herein, “terminal” and “terminal equipment” can be portable, transportable, installed in the (aviation, maritime and/or land) transport, or suitable and/or configured to operate locally, and/or operate in any other place on the earth and/or space in a distributed manner. As used herein, “terminal” and “terminal equipment” can also be a communication terminal, an Internet terminal and a music/video playing terminal, such as PDA, MID (Mobile Internet Device) and/or a mobile phone with music/video playing functions, a smart TV, a set-top box and other devices.

The term “transmit” in the present invention may be used interchangeably with “send”, “report”, “notify” and the like without departing from the scope of the present invention.

The text and drawings are only provided as examples to assist readers in understanding the present disclosure. They are not intended and should not be construed to limit the scope of the present disclosure in any way. While certain embodiments and examples have been provided, it will be apparent to those skilled in the art based on the disclosure herein that the illustrated embodiments and examples can be modified without departing from the scope of the present disclosure.

Transmission in the wireless communication system mainly includes: downlink transmission from the 5G gNB to the User Equipment (UE), and uplink transmission from the UE to the network.

Transmission nodes used for positioning in wireless communication systems such as current wireless communication systems include: a UE that initiates positioning request information, a Location Management Function (LMF) for UE positioning and positioning assistance data distribution, a gNB or a Transmission-Reception Point (TRP) for broadcasting positioning assistance data and uplink positioning measurement, and a UE for downlink positioning measurement.

For example, in the current wireless communication system, the 5G NR(New Radio, NR) can be switched among three Radio Resource Control (RRC) states, namely RRC_CONNECTED state, RRC_INACTIVE mode and RRC_IDLE state. Compared with LTE, in order to further reduce signaling overhead and power consumption, the 5G introduces the RRC_INACTIVE mode to reduce the control plane delay and terminal power consumption. The RRC_INACTIVE mode can be mutually converted with the RRC_CONNECTED state, or the RRC_IDLE state can be entered by releasing the RRC connection. Under different RRC states, there is a first downlink signal in the system. The first downlink signal can be the synchronization signal block (SSB) signal, the system information block 1 (SIB1), the control resource set 0 (CORESET0) signal, the message 2 (MSG2)/message B (MSGB) signal, the paging signal and the downlink small data transmission (DL SDT) signal, which are used for basic monitoring and measuring for signals or channels. To realize positioning measurement in the RRC_INACTIVE mode, it is stipulated that the priority of the DL PRS is lower than that of the first downlink signal. The UE needs a certain time to process the DL PRS and/or the first downlink signal. Therefore, how the UE determines that there is a conflict/collision between the DL PRS and the first downlink signal and how to receive the downlink signal when there is a conflict is a problem that needs to be solved. Specifically, according to the embodiment of the invention, there is provided a method for receiving and measuring positioning signals. In the receiving and measuring method of the positioning signal provided by the present invention, taking the DL PRS in the cellular network as an example, it can be extended to other networks and/or other positioning-related reference signals. In order to avoid that UE can't handle the conflict between different signals in time, such as the conflict between the DL PRS and other downlink signals (wherein the other downlink signals may be the first downlink signal), the present invention proposes a method on how the UE can determine that the DL PRS conflicts with the first downlink signal; and/or the UE is expected to receive the DL PRS and the first downlink signal at the same time; and/or the UE is expected to receive the first downlink signal preferentially and/or not expected to receive the DL PRS.

For example, in the RRC_INACTIVE/RRC_IDLE mode, if the priority of receiving the DL PRS is lower than that of the first downlink signal by the UE, when the time interval between other downlink signals such as the first downlink signal and the DL PRS is less than (or not greater than) the first threshold T, and/or the frequency domain interval is less than (or not greater than) the second threshold F, the UE in the RRC_INACTIVE/RRC_IDLE mode is expected to prioritize the reception of any other downlink signals such as the first downlink signal, and/or the UE is not expected to receive the DL PRS. When the time interval between other downlink signals such as the first downlink signal and the DL PRS is not less than (or greater than) the first threshold T, and/or the frequency domain interval is not less than (or greater than) the second threshold F, the UE in the RRC_INACTIVE/RRC_IDLE mode is expected to prioritize the reception of DL PRS, and/or the UE is not expected to receive any other downlink signals such as the first downlink signal. The first threshold and/or the second threshold may be a threshold parameter value configured by the base station equipment, and/or (when the threshold parameter value configured by the base station equipment is not provided) a value N (e.g., T=N) reported by the UE subject to UE capability. Preferably, when the time (and/or frequency domain) interval between the first downlink signal and the DL PRS is compared with the first threshold, the first downlink signal can be replaced by the start position or the end position of the time unit (and/or frequency domain unit) where the first downlink signal is located. The DL PRS can be replaced by the start position or the end position of the time unit (and/or frequency unit) where the DL PRS is located.

The UE determines that the DL PRS collides/conflicts with the first downlink signal when the condition that the DL PRS collides/conflicts with the first downlink signal is satisfied; otherwise, the UE determines that the DL PRS does not collide/conflict with the first downlink signal. Specifically, the conditions that the DL PRS collides/conflicts with the first downlink signal include the combination of one or more of the following:
There is overlapping/collision on part of and/or the total of frequency domain units of the same frequency band/carrier and/or different frequency bands/carriers.
On the time domain units of the same frequency band/carrier and/or different frequency bands/carriers, the time interval between the end position of the first downlink signal and the start position corresponding to the first DL PRS is smaller than the threshold value N1, and/or the time interval between the end position of the DL PRS and the start position corresponding to the first downlink signal is smaller than the threshold value N2, where N1 is the time unit value (reported by UE) that satisfies the time delay such as processing delay and handover/callback delay of the first downlink signal, and N2 is the time unit value (reported by UE) that satisfies the time delay such as processing delay and handover/callback delay of the DL PRS. N1 and N2 are real numbers greater than or equal to 0, and N1 can be the same value as N2. When N1=0 and/or N2=0, the DL PRS overlaps with the first downlink signal in the time domain symbol.

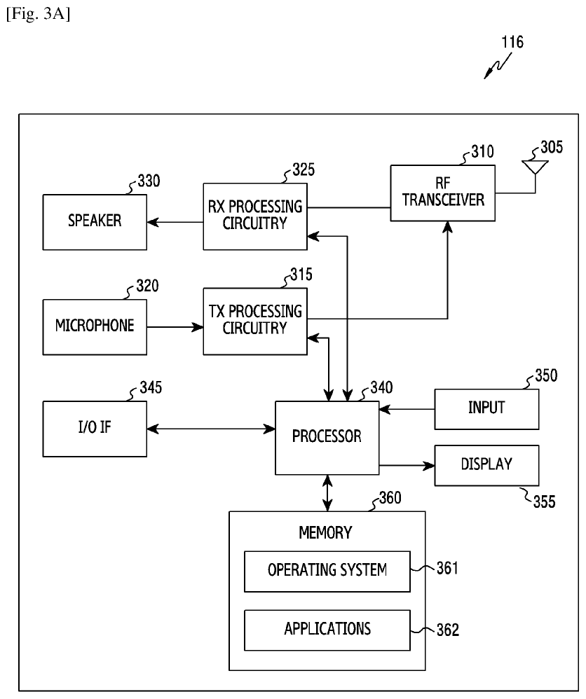

In the process of performing positioning measurement, if the UE determines that there is no conflict/collision between the DL PRS and the first downlink signal, for example, when the time interval between the end position of the first downlink signal and the start position corresponding to the DL PRS is greater than the threshold N1 and/or the time interval between the end position of the DL PRS and the start position corresponding to the first downlink signal is greater than the threshold N2, the UE is expected to receive the DL PRS and the first downlink signal simultaneously when the conditions for receiving the DL PRS and the first downlink signal at the same time are satisfied. Specifically, the conditions for receiving the DL PRS and the first downlink signal at the same time include a combination of one or more of the following:
When the DL PRS resource is inside the BWP where the first downlink signal is located and/or has the same numerology configuration (such as subcarrier spacing and/or cyclic prefix type configuration) as the BWP, for example, when the DL PRS has the same subcarrier spacing and/or cyclic prefix type as the first downlink signal in the initial BWP, as shown in FIG. 4-1, if the time interval between the time domain end position of the first downlink signal and the time domain start position corresponding to the (nearest first) DL PRS is greater than the threshold t1, and the time interval between the time domain end position of the same DL PRS or the last same DL PRS when repeated or the last DL PRS for multiple DL PRS measurements and the corresponding time domain start position of the (nearest next) first downlink signal is greater than the threshold t2, the UE is expected to receive the DL PRS and the first downlink signal simultaneously. Wherein t1 and t2 are real numbers greater than or equal to 0, t1≥N1, t2≥N2, and t1 can be equal to t2. Preferably, t1=0, and t2=0.
When the DL PRS resource is inside the BWP where the first downlink signal is located and/or has a different numerology configuration (such as subcarrier spacing and/or cyclic prefix type configuration) as the BWP, for example, when the DL PRS has different subcarrier spacing and/or cyclic prefix type from the first downlink signal in the initial BWP, as shown in FIG. 4-2, if the time interval between the time domain end position of the first downlink signal and the time domain start position corresponding to the (nearest first) DL PRS is greater than the threshold t3, and the time interval between the time domain end position of the same DL PRS or the last same DL PRS when repeated or the last DL PRS for multiple DL PRS measurements and the corresponding time domain start position of the (nearest next) first downlink signal is greater than the threshold t4, then the UE is expected to receive the DL PRS and the first downlink signal simultaneously. Wherein t3 and t4 are real numbers greater than or equal to 0, t3≥N1, t4≥N2, and t3 can be equal to t4. Preferably, t3=0, and t4=0.
When the DL PRS resource is outside the BWP where the first downlink signal is located, and/or has the same or different numerology configuration (such as subcarrier spacing and/or cyclic prefix type configuration) as the BWP, for example, when the DL PRS has the same and/or different subcarrier spacing and/or cyclic prefix type with the first downlink signal outside the initial BWP, as shown in FIG. 4-3, if the time interval between the time domain end position of the first downlink signal and the time domain start position corresponding to the (nearest first) DL PRS is greater than the threshold L-t5 (wherein L is the start position of the instance of a PRS resource, and there is no first downlink signal transmission in this period L), and the time interval between the time domain end position of the same DL PRS or the last same DL PRS when repeated or the last DL PRS for multiple DL PRS measurements and the corresponding time domain start position of the (latest first) first downlink signal is greater than the threshold t6, the UE is expected to receive the DL PRS and the first downlink signal simultaneously. Wherein t5, t6 and L are real numbers greater than or equal to 0, t5≥N1, t6≥N2, and t5 can be equal to t6. Preferably, t5=0, and t6=0.

In the process of performing positioning measurement, for example, in the RRC_INACTIVE/RRC_IDLE mode, considering that the priority of the DL PRS is lower than that of the first downlink signal, if the UE determines that the DL PRS collides with the first downlink signal, and when the conditions for prioritizing the reception of the first downlink signal and/or not expecting to receive the DL PRS are satisfied, the UE is expected to prioritize the reception of the first downlink signal and/or is not expected to receive the DL PRS. Specifically, the conditions for prioritizing the reception of the first downlink signal and/or not expecting to receive the DL PRS include a combination of one or more of the following:
When the DL PRS resource is inside the BWP where the first downlink signal is located and/or has the same numerology configuration (such as subcarrier spacing and/or cyclic prefix type configuration) as the BWP, for example, when the DL PRS has the same subcarrier spacing and/or cyclic prefix type with the first downlink signal in the initial BWP, as shown in FIG. 4-1, in order to avoid invalid handover (the invalid handover is defined as a situation although the reception of the DL PRS is allowed, it cannot be switched back to the original configuration in time to receive the first downlink signal with high priority after the reception of the DL PRS,), if the time interval between the time domain end position of the first downlink signal and the time domain start position corresponding to the (nearest first) DL PRS is greater than the threshold t1, but the time interval between the time domain end position of the same DL PRS or the last same DL PRS when repeated or the last DL PRS for multiple DL PRS measurements and the corresponding time domain start position of the (nearest next) first downlink signal is smaller than the threshold t2, the UE is expected to receive the first downlink signal preferentially and/or is not expected to receive the DL PRS.
When the DL PRS resource is inside the BWP where the first downlink signal is located and/or has a different numerology configuration (such as subcarrier spacing and/or cyclic prefix type configuration) as the BWP, for example, when the DL PRS has different subcarrier spacing and/or cyclic prefix type from the first downlink signal in the initial BWP, as shown in FIG. 4-2, in order to avoid invalid handover, if the time interval between the time domain end position of the first downlink signal and the time domain start position corresponding to the (nearest first) DL PRS is greater than the threshold t3, but the time interval between the time domain end position of the same DL PRS or the last same DL PRS when repeated or the last DL PRS for multiple DL PRS measurements and the corresponding time domain start position of the (nearest next) first downlink signal is less than the threshold t4, the UE is expected to receive the first downlink signal preferentially and/or is not expected to receive the DL PRS.
When the DL PRS resource is outside the BWP where the first downlink signal is located, and/or has the same or different numerology configuration (such as subcarrier spacing and/or cyclic prefix type configuration) as the BWP, for example, when the DL PRS has the same and/or different subcarrier spacing and/or cyclic prefix type with the first downlink signal outside the initial BWP, as shown in FIG. 4-3, in order to avoid the invalid handover, if the time interval between the time domain end position of the first downlink signal and the time domain start position corresponding to the (nearest first) DL PRS is greater than the threshold L-t5, but the time interval between the time domain end position of the same DL PRS or the last same DL PRS when repeated or the last DL PRS for multiple DL PRS measurements and the corresponding time domain start position of the (nearest next) first downlink signal is less than the threshold t6, the UE is expected to receive the first downlink signal preferentially and/or is not expected to receive the DL PRS.

Preferably, the UE determines the values of the time interval thresholds N1, N2 and/or t1, t2, t3, t4, t5, t6 in the time domain between the DL PRS and the first downlink signal by default and/or in a manner indicated by the base station. The default method is intended that when the time interval threshold value is not provided, the UE could determine the time interval threshold value autonomously, for example, the UE determines that t1=N1, t3=N1, t5=N1, t2=N2, t4=N2, and t6=N2. In the mode indicated by the base station, the base station configures the threshold of the time interval, for example, the base station configures it through the RRC message and the MAC CE message.

Preferably, the UE determine the DL PRS conflicts/collides with the first downlink signal within a specific window by the method described above; and/or UE is expected to receive the DL PRS and the first downlink signal simultaneously; and/or UE is expected to prioritize the reception of the first downlink signal and/or is not expected to receive the DL PRS, and obtains the time interval indication when the DL PRS and the first downlink signal do not conflict/collide in time domain. The specific window can be a measurement interval and/or the PRS processing window and/or a new window defined for measuring the PRS (or obtaining positioning information).

Subject to UE capability, the UE may be configured with an SRS resource for positioning including frequency location and bandwidth, numerology, and CP length for transmission of the SRS in RRC_INACTIVE mode. If the time interval between UL signals transmitted in the initial uplink bandwidth part (UL BWP) and/or other uplink bandwidth parts (UL BWPs) and one or more periodic SRSs for positioning transmitted in RRC_INACTIVE mode outside the initial uplink bandwidth part (UL BWP) and/or other uplink bandwidth parts (UL BWPs) is less than (or not greater than) the first threshold T, one or more SRSs for positioning is cancelled or dropped or not transmitted by the UE. For example, when the uplink signal is transmitted by using the preconfigured configured grant small data transmission (CG-SDT) in the initial uplink bandwidth part initial (UL BWP) and/or other uplink bandwidth parts (UL BWPs), if the time interval between these uplink signal and one or more periodic SRSs for positioning transmitted outside the initial uplink bandwidth part (UL BWP) and/or other uplink bandwidth parts (UL BWPs) is less than (or not greater than) the first threshold T, one or more SRSs for positioning is cancelled or dropped or not transmitted by the UE. When the uplink signal is transmitted by using random access small data transmission (RA-SDT) in the initial uplink bandwidth part (UL BWP) and/or other uplink bandwidth parts (UL BWPs) in a scheduled manner, if the time interval between these uplink signal and the one or more periodic SRSs for positioning transmitted outside the initial uplink bandwidth part (UL BWP) and/or other uplink bandwidth parts (UL BWPs) is less than (or not greater than) the first threshold T, one or more SRSs for positioning is cancelled or dropped or not transmitted by the UE.

Subject to UE capability, the UE may be configured with an SRS resource for positioning including frequency location and bandwidth, numerology, and CP length for transmission of the SRS in RRC_INACTIVE mode. If the time interval between UL signals transmitted in the initial uplink bandwidth part (UL BWP) and/or other uplink bandwidth parts (UL BWPs) and one or more periodic SRSs for positioning transmitted in RRC_INACTIVE mode outside the initial uplink bandwidth part (UL BWP) and/or other uplink bandwidth parts (UL BWPs) is greater than the third threshold T1, the UE is allowed or expected to transmit the one or more SRSs for positioning. For example, when the uplink signal is transmitted by using the preconfigured configured grant small data transmission (CG-SDT) in the initial uplink bandwidth part (UL BWP) and/or other uplink bandwidth parts (UL BWPs), if the time interval between these uplink signal and the one or more periodic SRSs for positioning transmitted outside the initial uplink bandwidth part (UL BWP) and/or other uplink bandwidth parts (UL BWPs) is greater than the third threshold T1, the UE is allowed or expected to transmit the one or more SRSs for positioning. When the uplink signal is transmitted by using random access small data transmission (RA-SDT) in the initial uplink bandwidth part (UL BWP) and/or other uplink bandwidth parts (UL BWPs) in a scheduled manner, if the time interval between these uplink signal and the one or more periodic SRSs for positioning transmitted outside the initial uplink bandwidth part (UL BWP) and/or other uplink bandwidth parts (UL BWPs) is greater than the third threshold T1, the UE is allowed or expected to transmit the one or more SRSs for positioning. Wherein the third threshold T1 is a threshold parameter value determined by the user equipment (UE) subject to UE capability and/or a threshold parameter value configured by the base station equipment and received by the user equipment (UE).

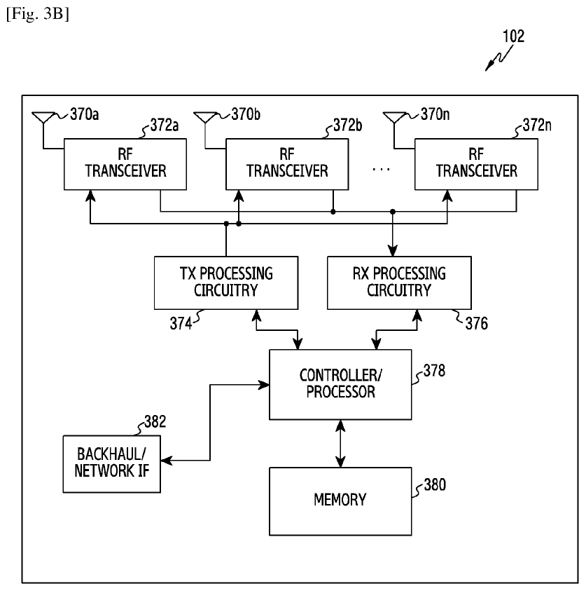

Referring to FIG. 5, the embodiment also provides an electronic device (user equipment) 500 for receiving and measuring a positioning signal. The user equipment includes a memory 501 and a processor 502, wherein computer-executable instructions are stored in the memory, and when the instructions are executed by the processor 502, at least one method corresponding to the above embodiments of the disclosure is executed. The above is only a preferred embodiment of the present invention, and it is not intended to limit the present invention. Any modifications, equivalents, improvements, etc. made within the spirit and principle of the present invention should be included in the scope of the present invention.

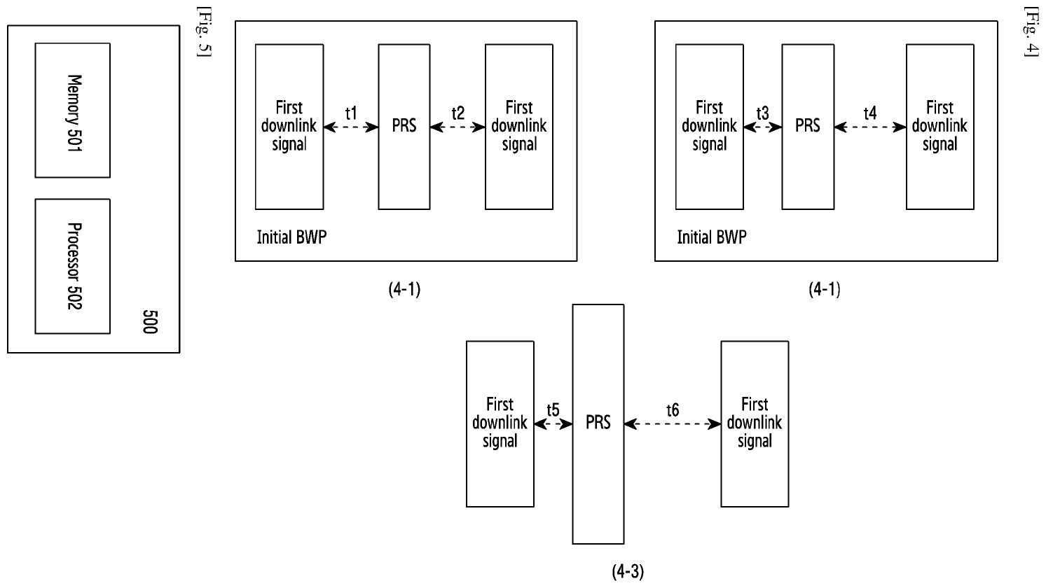

FIG. 6 illustrates a block diagram of a terminal (or a user equipment (UE)), according to embodiments of the present disclosure.

As shown in FIG. 6, a terminal according to an embodiment may include a transceiver 610, a memory 620, and a processor (or a controller) 630. The transceiver 610, the memory 620, and the processor (or controller) 630 of the terminal may operate according to a communication method of the terminal described above. However, the components of the terminal are not limited thereto. For example, the terminal may include more or fewer components than those described in FIG. 6. In addition, the processor (or controller) 630, the transceiver 610, and the memory 620 may be implemented as a single chip. Also, the processor (or controller) 630 may include at least one processor.

The transceiver 610 collectively refers to a terminal station receiver and a terminal transmitter, and may transmit/receive a signal to/from a base station or another terminal. The signal transmitted or received to or from the terminal may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor (or controller) 630, a signal through a wireless channel, and transmit a signal output from the processor (or controller) 630 through the wireless channel.

The memory 620 may store a program and data required for operations of the terminal. Also, the memory 620 may store control information or data included in a signal obtained by the terminal. The memory 620 may be a storage medium, such as read-only memory (ROM), random access memory (RAM), a hard disk, a CD-ROM, and a DVD, or a combination of storage media.

The processor (or controller) 630 may control a series of processes such that the terminal operates as described above. For example, the processor (or controller) 630 may receive a data signal and/or a control signal, and the processor (or controller) 630 may determine a result of receiving the signal transmitted by the base station and/or the other terminal.

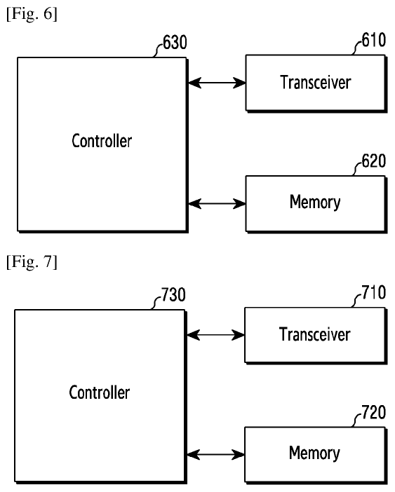

FIG. 7 illustrates a block diagram of a base station, according to embodiments of the present disclosure.

As shown in FIG. 7 is, the base station of the present disclosure may include a transceiver 710, a memory 720, and a processor (or, a controller) 730. The transceiver 710, the memory 720, and the processor (or controller) 730 of the base station may operate according to a communication method of the base station described above. However, the components of the base station are not limited thereto. For example, the base station may include more or fewer components than those described in FIG. 7. In addition, the processor (or controller) 730, the transceiver 710, and the memory 720 may be implemented as a single chip. Also, the processor (or controller) 730 may include at least one processor.

The transceiver 710 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor (or controller) 730, a signal through a wireless channel, and transmit a signal output from the processor (or controller) 730 through the wireless channel.

The memory 720 may store a program and data required for operations of the base station. Also, the memory 720 may store control information or data included in a signal obtained by the base station. The memory 720 may be a storage medium, such as ROM, RAM, a hard disk, a CD-ROM, and a DVD, or a combination of storage media.

The processor (or controller) 730 may control a series of processes such that the base station operates as described above. For example, the processor (or controller) 730 may receive a data signal and/or a control signal, and the processor (or controller) 730 may determine a result of receiving the signal transmitted by the terminal and/or the core network function.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

It can be understood by those skilled in the art that the present invention includes devices for performing one or more of the operations described in this application. These devices can be specially designed and manufactured for the required purposes, or they can also include known devices in general-purpose computers. These devices have stored therein computer programs that are selectively activated or reconfigured. Such a computer program can be stored in a device (e.g., computer) readable medium or in any type of medium suitable for storing electronic instructions and respectively coupled to a bus, including but not limited to any type of disk (including floppy disk, hard disk, optical disk, CD-ROM, and magneto-optical disk), ROM (Read-Only Memory), RAM (Random Access Memory), EPROM (erasable programmable read-only memory), EEPROM (electrically erasable programmable read-only memory), flash memory, magnetic card or optical card. That is, a readable medium includes any medium that stores or transmits information in a readable form by a device (e.g., a computer).

It can be understood by those skilled in the art that each block in these structural diagrams and/or block diagrams and/or flow diagrams and combinations of blocks in these structural diagrams and/or block diagrams and/or flow diagrams can be implemented by computer program instructions. Those skilled in the art can understand that these computer program instructions can be provided to a processor of a general-purpose computer, a professional computer or other programmable data processing methods for implementation, so that the scheme specified in the block or blocks of the structure diagram and/or block diagram and/or flow diagram disclosed by the present invention can be executed by the processor of the computer or other programmable data processing methods.

Those skilled in the art can understand that the steps, measures and schemes in various operations, methods and processes already discussed in the present invention can be alternated, changed, combined or deleted. Furthermore, other steps, measures and schemes having the various operations, methods and processes already discussed in the present invention can also be alternated, changed, rearranged, decomposed, combined or deleted. Furthermore, the steps, measures and schemes in various operations, methods and processes disclosed in the prior art can also be alternated, changed, rearranged, decomposed, combined or deleted.

The above is only a partial embodiment of the present invention. It should be pointed out that for those skilled in the art, without departing from the principle of the present invention, several improvements and embellishments can be made, which should also be regarded as the protection scope of the present invention.

1. A method performed by a user equipment (UE) in a wireless communication system, the method comprising:
identifying a first transmission of a sounding reference signal (SRS) for positioning outside an initial uplink bandwidth part (BWP) and a second transmission of an uplink signal; and
in case that the first transmission collides in time domain with the second transmission, dropping the first transmission.

2. The method of claim 1, wherein the first transmission is dropped, in case that a first time interval between the first transmission and the second transmission is less than a first threshold.

3. The method of claim 1, wherein the first transmission is performed while the UE is in a radio resource control (RRC) inactive mode.

4. The method of claim 1, wherein the second transmission of the uplink signal includes at least one of a configured grant small data transmission (CG-SDT) or a random access small data transmission (RA-SDT).

5. The method of claim 2, further comprising:
in case that the first time interval between the first transmission and the second transmission is larger than the first threshold, transmitting the first transmission and the second transmission.

6. The method of claim 1, further comprising:
identifying that a first reception of a downlink positioning reference signal collides with a second reception of a downlink signal, in case that a portion of the second reception overlaps with starting N symbols before the first reception and ending N symbols after the first reception, and
wherein the N is a positive integer.

7. The method of claim 6, wherein the first reception collides with the second reception, in case that a second time interval between an end of the first reception and a start of the second reception or an end of the second reception and a start of the first reception is less than a second threshold.

8. The method of claim 6, wherein the first reception is outside an initial downlink BWP.

9. A user equipment (UE) in a wireless communication system, the UE comprising:
a transceiver; and
a controller coupled with the transceiver and configured to:
identify a first transmission of a sounding reference signal (SRS) for positioning outside an initial uplink bandwidth part (BWP) and a second transmission of an uplink signal, and
in case that the first transmission collides in time domain with the second transmission, drop the first transmission.

10. The UE of claim 9, wherein the first transmission is dropped, in case that a first time interval between the first transmission and the second transmission is less than a first threshold.

11. The UE of claim 9, wherein the first transmission is performed while the UE is in a radio resource control (RRC) inactive mode.

12. The UE of claim 9, wherein the second transmission of the uplink signal includes at least one of a configured grant small data transmission (CG-SDT) or a random access small data transmission (RA-SDT).

13. The UE of claim 10, wherein the controller is further configured to:
in case that the first time interval between the first transmission and the second transmission is larger than the first threshold, transmit the first transmission and the second transmission.

14. The UE of claim 9, wherein the controller is further configured to:
identify that a first reception of a downlink positioning reference signal collides with a second reception of a downlink signal, in case that a portion of the second reception overlaps with starting N symbols before the first reception and ending N symbols after the first reception,
wherein the N is a positive integer, and
wherein the first reception is outside an initial downlink BWP.

15. The UE of claim 14, wherein the first reception collides with the second reception, in case that a second time interval between an end of the first reception and a start of the second reception or an end of the second reception and a start of the first reception is less than a second threshold.
